(19) United States
(12) Patent Application Publication
(10) Pub. No.: US 2023/0083930 A1
(43) Pub. Date: Mar. 16, 2023

(54) METHOD AND APPARATUS FOR GENERATING SIGNAL

(71) Applicant: FUJITSU LIMITED, Kawasaki-shi (JP)

(72) Inventors: Ke ZHANG, Beijing (CN); Zhenning TAO, Beijing (CN); Xiaofei SU, Beijing (CN); Tong YE, Beijing (CN)

(73) Assignee: FUJITSU LIMITED, Kawasaki-shi (JP)

(21) Appl. No.: 17/900,325

(22) Filed: Aug. 31, 2022

(30) Foreign Application Priority Data
Sep. 15, 2021 (CN) 202111080763.8

(51) Int. Cl. H04L 27/26; H04L 5/00

(52) U.S. Cl. CPC H04L 27/2602; H04L 5/0048

(57) ABSTRACT

A method and apparatus for generating a signal. The method includes: by taking a reference signal as a standard, cyclically performing isoprobabilistic processing and isospectral processing, or cyclically perform isoprobabilistic processing, perturbation processing and isospectral processing, on an input signal, until an obtained signal satisfies both a requirement on a target probability distribution and a requirement on a target spectrum, where a probability distribution of the reference signal satisfying the requirement on a target probability distribution, the isoprobabilistic processing referring to processing that makes the probability distribution of an output signal identical to the probability distribution of the reference signal. Therefore, a signal that satisfies both the requirement on the specific probability distribution and the requirement on the spectrum can be generated, and the degree of compliance is higher.

### CROSS-REFERENCE TO RELATED APPLICATIONS

This application is based on and hereby claims priority to Chinese Application No. 202111080763.8, filed Sep. 15, 2022, in the China National Intellectual Property Administration, the disclosure of which is incorporated herein by reference.

### FIELD

The present disclosure relates to the field of communications, and particularly to a method and apparatus for generating a signal.

### Background

In a communication system, it is sometimes necessary to generate a signal according to a requirement on a certain probability distribution function (PDF) and a requirement on a spectrum. For example, in a nonlinear system, the nonlinear characteristics thereof are closely related to a probability distribution and a spectrum of an input signal, so it is necessary to generate a signal that can satisfy both a requirement on a specific spectrum distribution and a requirement on a probability distribution. Particularly, in a nonlinear noise measurement, it is necessary to remove frequency components of an input test signal in some frequency bands to form specific notch spectrum characteristics. Meanwhile, it is also required that the above notch process will not change probability distribution characteristics of the signal, so as to ensure the accuracy of a result obtained by the nonlinear noise measurement.

It should be noted that the above introduction to the technical background is only for the convenience of the clear and complete explanation of the technical solutions of the present disclosure and the understanding by those skilled in the art. It should not be considered that the above technical solutions are well known to those skilled in the art just because these solutions are described in the background section of the present disclosure.

### SUMMARY

According to an embodiment of the present disclosure, there is provided an apparatus including a memory and a processor coupled to the memory. The processor to control execution of a process including: a processing unit configured to, by taking a reference signal as a standard, cyclically perform isoprobabilistic processing and isospectral processing, or cyclically perform isoprobabilistic processing, perturbation processing and isospectral processing, on an input signal, until an obtained signal satisfies both a requirement on a target probability distribution and a requirement on a target spectrum, where a probability distribution of the reference signal satisfies the requirement on the target probability distribution. The isoprobabilistic processing refers to processing that makes a probability distribution of an output signal identical to a probability distribution of the reference signal; the perturbation processing refers to processing that makes a fine structure of a spectrum of an input signal randomly changed within a resolution bandwidth; and the isospectral processing refers to processing that makes a power distribution of a spectrum of the output signal close to a power distribution of the target spectrum.

According to an embodiment of the present disclosure, there is provided a measurement system of a nonlinear system. The measurement system including: the apparatus to generate a target signal; and a measuring device configured to measure nonlinear characteristics of the nonlinear system according to the target signal. According to an embodiment of the present disclosure, there is provided a test instrument, including: a signal generator configured to generate a target signal, the signal generator being implemented by the apparatus for generating a signal; and a test device configured to perform a test according to the target signal.

According to an embodiment of the present disclosure, there is provided a test instrument, including: a receiver configured to receive a target signal, the target signal being generated by the apparatus for generating a signal; and a test device configured to perform a test according to the target signal.

With reference to the following descriptions and drawings, the specific implementations of the present disclosure are disclosed in detail, and the ways in which the principle of the present disclosure can be adopted are pointed out. It should be understood that the implementations of the present disclosure are not limited thereby in scope. Within the scope of the clauses of the appended claims, the implementations of the present disclosure include many changes, modifications and equivalents.

The features described and/or illustrated for one implementation may be used in one or more other implementations in a same or similar way, and combined with or substituted for features in other implementations.

It should be emphasized that the term ‘comprise/include’ used herein refers to the presence of features, integers, steps or components, but does not exclude the presence or addition of one or more other features, integers, steps or components.

### BRIEF DESCRIPTION OF THE DRAWINGS

The elements and features described in one drawing or implementation of the embodiments of the present disclosure may be combined with the elements and features illustrated in one or more other drawings or implementations. In addition, in the drawings, similar reference numerals indicate corresponding parts in several drawings, and can be used to indicate corresponding parts used in more than one implementation.

The drawings, which are included to provide a further understanding of the embodiments of the present disclosure, constitute a part of the specification, illustrate the implementations of the present disclosure, and explain the principle of the present disclosure together with the textual description. Obviously, the drawings described below only illustrate some embodiments of the present disclosure, and those of ordinary skill in the art can obtain any other drawing from them without paying any creative labor. In the drawings:

FIG. 1 is a schematic diagram of an apparatus for generating a signal according to an embodiment of the present disclosure;

FIG. 2 is a schematic diagram of an implementation of isoprobabilistic processing according to an embodiment of the present disclosure;

FIG. 3 is a schematic diagram of another implementation of isoprobabilistic processing according to an embodiment of the present disclosure;

FIG. 4 is a schematic diagram of an implementation of perturbation processing according to an embodiment of the present disclosure;

FIG. 5 is a schematic diagram of an implementation of isospectral processing according to an embodiment of the present disclosure;

FIG. 6 is a schematic diagram of an implementation of a processing unit according to an embodiment of the present disclosure;

FIG. 7 is a schematic diagram of another implementation of a processing unit according to an embodiment of the present disclosure;

FIG. 8 is a schematic diagram of still another implementation of a processing unit according to an embodiment of the present disclosure;

FIG. 9 is a schematic diagram of yet another implementation of a processing unit according to an embodiment of the present disclosure;

FIG. 10 is a schematic diagram of a method for generating a signal according to an embodiment of the present disclosure;

FIG. 11 is a schematic diagram of a measurement system of a nonlinear system according to an embodiment of the present disclosure;

FIG. 12 is a schematic diagram of an implementation of a measurement system of a nonlinear system according to an embodiment of the present disclosure;

FIG. 13 is a schematic diagram of an implementation of a test instrument according to an embodiment of the present disclosure;

FIG. 14 is a schematic diagram of another implementation of a test instrument according to an embodiment of the present disclosure.

### DETAILED DESCRIPTION

The foregoing and other features of the present disclosure will become apparent from the following description with reference to the drawings. In the description and drawings, particular embodiments of the present disclosure are specifically disclosed to represent some embodiments in which the principle of the present disclosure can be adopted. It should be understood that the present disclosure is not limited to the described embodiments, and on the contrary, the present disclosure includes all modifications, variations and equivalents that fall within the scope of the appended claims.

In the embodiments of the present disclosure, the terms ‘first’, ‘second’, etc. are used to distinguish different elements in terms of titles, but they do not mean a spatial arrangement or a time sequence of these elements, and these elements should not be limited by them. The term ‘and/or’ includes any one and all combinations of one or more of terms listed in association. The terms ‘comprise’, ‘include’, ‘have’, etc. refer to the presence of the stated features, elements, members, or components, but do not exclude the presence or addition of one or more other features, elements, members or components. In the embodiments of the present disclosure, singular forms ‘a’, ‘the’, etc. include plural forms thereof, and should be broadly understood as ‘a kind of’ or ‘a category of’ rather than being limited to the meaning of ‘one’. In addition, the term ‘said’ should be understood to include both singular and plural forms, unless otherwise specified in the context explicitly. In addition, the term ‘according to’ should be understood as ‘at least partially according to . . . ’ and the term ‘based on’ should be understood as ‘at least partially based on . . . ’, unless otherwise specified in the context explicitly.

Respective implementations of the embodiments of the present disclosure are described below with reference to the drawings.

The inventor finds that, at present, there have been technologies that can generate a signal only satisfying a requirement on a specific probability distribution, such as a technology of Acceptance-Rejection Sampling. In addition, there also have been technologies that can generate a signal only satisfying a requirement on a specific spectrum distribution, such as filtering a white noise signal with a filter having a same frequency response as a target spectrum distribution. However, at present, there is no way to generate a signal that can satisfy both a requirement on a specific probability distribution and a requirement on a spectrum distribution.

To solve the above or similar problems, the embodiments of the present disclosure provide a method and apparatus for generating a signal. The embodiments of the present disclosure has the following advantageous effects:

according to the embodiments of the present disclosure, by adopting a process of cyclically performing isoprobabilistic processing and isospectral processing or a process of cyclically performing isoprobabilistic processing, perturbation processing and isospectral processing, a signal that satisfies both a requirement on a specific probability distribution and a requirement on a spectrum can be generated, and the degree of compliance is higher compared with the prior art. In addition, the present disclosure has no limitation on the probability distribution type of the target signal, which may be a continuous variable, a discrete variable, a real variable or a complex variable. Thus, the generated signal can be used to measure nonlinear characteristics, and if the target signal is a notched signal, a nonlinearity of the system can be conveniently and accurately evaluated by the embodiments of the present disclosure.

Embodiments of a First Aspect

The embodiments of the present disclosure provide an apparatus for generating a signal. The apparatus is configured in an optical communication system, but the present disclosure is not limited thereto. The apparatus can also be configured in any other communication system that needs to generate a signal that satisfies both a requirement on a specific probability distribution and a requirement on a spectrum.

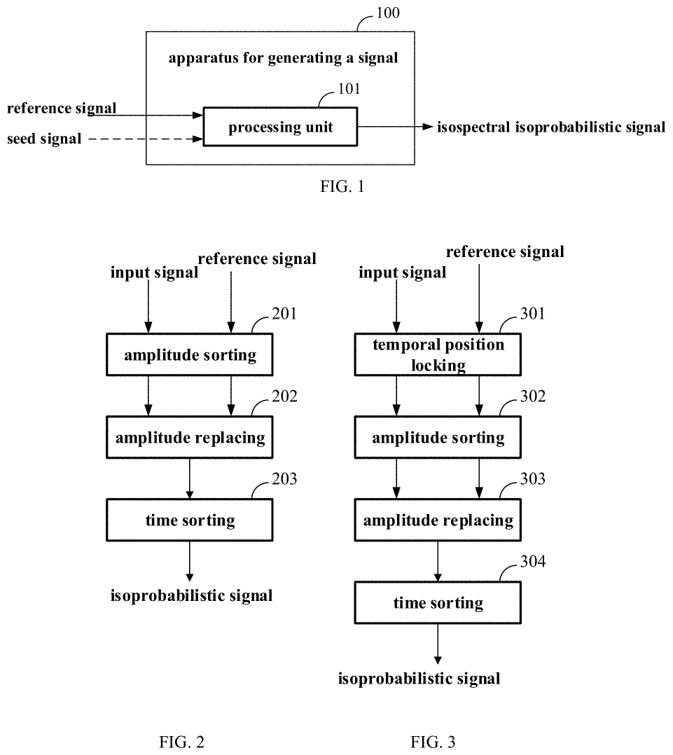

FIG. 1 is a schematic diagram of an example of an apparatus for generating a signal according to an embodiment of the present disclosure. As illustrated in FIG. 1, the apparatus 100 includes a processing unit 101 configured to, by taking a reference signal as a standard, cyclically perform isoprobabilistic processing and isospectral processing, or cyclically perform isoprobabilistic processing, perturbation processing and isospectral processing, on an input signal, until an obtained signal satisfies both a requirement on a target probability distribution and a requirement on a target spectrum. The probability distribution of the reference signal satisfies the requirement on the target probability distribution, that is, the target probability distribution is provided by the reference signal, or the target probability distribution is given in the form of the reference signal, and the probability distribution of the reference signal is the same as the target probability distribution, so that the finally obtained signal can satisfy the requirement on the target probability distribution. The isoprobabilistic processing refers to processing that makes a probability distribution of an output signal identical to a probability distribution of the reference signal; the perturbation processing refers to processing that makes a fine structure of a spectrum of an input signal randomly changed within a resolution bandwidth; and the isospectral processing refers to processing that makes a power distribution of a spectrum of the output signal close to a power distribution of the target spectrum.

According to the embodiments of the present disclosure, by adopting a process of cyclically performing isoprobabilistic processing and isospectral processing or a process of cyclically performing isoprobabilistic processing, perturbation processing and isospectral processing, a signal that satisfies both a requirement on a specific probability distribution and a requirement on a spectrum can be generated, and the degree of compliance is higher compared with the prior art.

In the above embodiments, the isoprobabilistic processing and the isospectral processing, or the isoprobabilistic processing, the perturbation processing and the isospectral processing, are cyclically and iteratively operated. The input signal in a first iterative operation is a seed signal, and from a second iterative operation, the input signal is an isospectral signal obtained through feedback. In the embodiment of the present disclosure, the seed signal may be a random white noise signal, a MultiTone signal with an equal amplitude and a random phase, or any other type of signal. That is, in the embodiment of the present disclosure, there is no requirement on the probability distribution of the seed signal (i.e., the input signal in the first iterative operation), and it may be a Gaussian distribution, a uniform distribution or any other type of distribution.

In the above embodiment, the processing unit 101 performs isoprobabilistic processing on the input signal, which means that the processing unit 101 generates an isoprobabilistic signal by using the input signal (as mentioned above, it may be a seed signal or an isospectral signal) and the reference signal, and the isoprobabilistic signal has a probability distribution the same as that of the reference signal and a spectrum slightly different from that of the input signal, that is, most of the spectrum characteristics of the input signal can be retained in the isoprobabilistic signal.

FIG. 2 is a schematic diagram of isoprobabilistic processing. As illustrated in FIG. 2, the isoprobabilistic processing includes amplitude sorting 201, amplitude replacing 202 and time sorting 203.

In the amplitude sorting 201, the processing unit 101 sorts the input signal and the reference signal respectively according to amplitudes of their respective data sample points (e.g., in an ascending order or a descending order), and records temporal position coordinates of the data sample points of the input signal, which have been arranged in an ascending order or a descending order of the amplitudes, in an original signal sequence. The input signal and the reference signal are sorted in the same way, e.g., they are all sorted in the descending order or the ascending order of the amplitudes of the data sample points.

In the amplitude replacing 202, the processing unit 101 replaces amplitudes of the sorted data sample points of the input signal with amplitudes of the sorted data sample points of the reference signal.

In the time sorting 203, the processing unit 101 resorts all data sample points of the input signal with the amplitudes replaced in a sequential order according to recorded temporal position coordinates, and the resorted signal is an isoprobabilistic signal.

It should be noted that the above isoprobabilistic processing is only schematically described by taking FIG. 2 as an example, but the present disclosure is not limited thereto. For example, the respective steps may be adjusted appropriately, and some other steps may be added or some of the existing steps may be reduced. Those skilled in the art can make appropriate modifications according to the above content, as long as the probability density distribution of the output signal is the same as that of the reference signal, without being limited to the illustration of FIG. 2.

For example, in some embodiments, when the target signal is required to satisfy not only the requirement on the specific probability distribution and the requirement on the spectrum, but also some specific constraints in time domain, e.g., the target signal should be a specific pilot signal or a training sequence signal at some specific temporal positions, all data sample points of the input signal and the reference signal at the specific required temporal positions may be locked, so that they do not participate in a subsequent process of the isoprobabilistic processing. FIG. 3 is another schematic diagram of isoprobabilistic processing. As illustrated in FIG. 3, the isoprobabilistic processing includes temporal position locking 301, amplitude sorting 302, amplitude replacing 303 and time sorting 304.

In the temporal position locking 301, the processing unit 101 locks all data sample points of the input signal and the reference signal located at required temporal positions, so that they do not participate in a subsequent process of the isoprobabilistic processing.

In the amplitude sorting 302, the processing unit 101 sorts other data sample points of the input signal and the reference signal respectively according to their respective amplitudes (e.g., in an ascending order or a descending order), and records temporal position coordinates of the other sorted data sample points of the input signal in the original signal sequence. The other data sample points of the input signal and the reference signal are sorted in the same way, e.g., they are all sorted in the descending order or the ascending order, as mentioned above.

In the amplitude replacing 303, the processing unit 101 replaces amplitudes of the other sorted data sample points of the input signal with amplitudes of the other sorted data sample points of the reference signal;

In the time sorting 304, the processing unit 101 resorts all data sample points of the input signal with the amplitudes replaced according to the recorded temporal position coordinates, so as to obtain an isoprobabilistic signal. In the example of FIG. 3, the processing of the amplitude sorting 302, the amplitude replacing 303 and the time sorting 304 are the same as the processing of the amplitude sorting 201, the amplitude replacing 202 and the time sorting 203 in the example of FIG. 2, and the explanations thereof are omitted here.

In the example of FIG. 3, the sample point datas of the reference signal at the required temporal positions have been replaced with the specific pilot signals or training sequence signals. All data sample points of the input signal and the reference signal at the specific required temporal positions are locked by the temporal position locking 301, it can be ensured that the specific pilot signals or training sequence signals are located at these specific temporal positions.

In the above embodiment, the processing unit 101 performs perturbation processing on the input signal, which means that the processing unit 101 performs perturbation processing on an input isoprobabilistic signal, so that a fine structure of a spectrum of the signal changes randomly within a resolution bandwidth, and the output signal is a perturbation signal.

FIG. 4 is a schematic diagram of perturbation processing. As illustrated in FIG. 4, the perturbation processing includes time-frequency domain transforming 401, spectrum interval dividing 402 and perturbing 403.

In the time-frequency domain transforming 401, the processing unit 101 transforms the input signal from time domain to frequency domain.

In the spectrum interval dividing 402, the processing unit 101 divides the entire spectrum of the input signal into multiple frequency intervals. The number of the divided intervals depends on the actual resolution requirement, and it may be tens, hundreds or even thousands and it is a preset parameter, which is not limited in the present disclosure. In addition, the resolution requirement determines the spectral resolution under which the spectrum of the finally obtained signal satisfies the requirement on the target spectrum distribution.

In the perturbing 403, the processing unit 101 performs a perturbation on frequency components of the input signal in the frequency intervals so as to change fine structures of spectral lines in the frequency intervals, thereby obtaining a perturbation signal.

The basic rule of perturbation is to make the input signal be subjected to a controllable random change within the interval, so as to avoid the signal generation from being trapped in a local optimal solution in the iterative process. In addition, the degree of perturbation can be controlled by a parameter. In some embodiments, the perturbation is a coordination perturbation, that is, the divisions for the frequency intervals are at equal intervals, all frequency intervals are subjected to the same perturbation, and coordination perturbation processes of an iteration and a subsequent iteration are independent of each other.

Assuming that the entire spectrum is divided into M frequency intervals, each of which includes N spectral lines, an n-th spectral line of an m-th interval may be expressed as Pₘᵢₙ. In each iteration, it generates a new set of perturbation coefficient vectors Wₙ(1≤n≤N) with a length of N, such as an array of Gaussian random variables with a mean value of 1 and a standard deviation of α. α is a parameter that controls the degree of perturbation (i.e., the magnitude of perturbation) and can be selected according to actual needs. In addition, α may be fixed or variable, that is, the value of a in each iteration may be different, for example, the value of α may be gradually decreased along with the iteration process, which is not limited in the present disclosure.

The above way of generating the perturbation coefficient vectors is only an example, and is not limited in the present disclosure. For example, the perturbation coefficient vectors may be generated in other ways, such as an array of uniformly distributed random variables, etc.

After the perturbation coefficient vector Wₐ is obtained, a coordination perturbation may be performed on all the intervals by using the perturbation coefficient vector. The n-th spectral line of the m-th interval after perturbation may be expressed as:

P′_{m,n}=P_{m,n}×Wₐ(1≤m≤M)

As can be seen from the above formula, the coordination perturbation means that the perturbation coefficients of all the n-th spectral lines in all the intervals are the same, where α=0 means that there is no perturbation, and the perturbation becomes stronger as α increases.

The perturbing 403 is described above by taking the cooperative perturbation as an example, which is not limited in the present disclosure, and the perturbing 403 also may not be a cooperative perturbation. For example, different coefficients W may be adopted for different intervals m. At this time, the n-th spectral line of the m-th interval after perturbation may be expressed as:

P′_{m,n}=P_{m,n}×W_{m,n}(1≤m≤M)

In the above formula, the coefficient W is a matrix rather than a vector.

In the previous examples, the perturbing 403 is performed on the amplitude, but the present disclosure is not limited thereto, and the perturbing 403 may also be performed on the phase. For example, the n-th spectral line of the m-th interval after perturbation may be expressed as:

P′_{m,n}=P_{m,n}×exp(jϕₙ)(1≤m≤M)

In the above formula, ϕₙ is a real random number with a mean value of 0 and a standard deviation of α, where α=0 means that there is no perturbation, and the perturbation becomes stronger as α increases.

In some other embodiments, the perturbing 403 may also be an amplitude change or a phase change in a probabilistic sense. For example, each element of Wₙ obeys a binomial distribution of 1 and A, where the probability of A is α, and the probability of 1 is 1−α. Then the n-th spectral line of the m-th interval after perturbation may be expressed as:

P′_{m,n}=P_{m,n}×Wₐ(1≤m≤M)

In the above formula, the n-th spectral line multiplies a change amplitude A according to the probability α, where α and A are parameters used to control the degree of perturbation (i.e., the magnitude of perturbation).

In some other embodiments, the perturbing 403 may also be a permutation in the sense of probability. For example, each element of Wₙ obeys a binomial distribution of 0 and 1, where the probability of 1 is α, and the probability of 0 is 1−α. After a distribution result is obtained, all spectral lines corresponding to coordinate n with Wₙ valued as 1 are picked out, and then subjected to a random permutation.

The perturbing 403 is described above through several examples, and it is not limited in the present disclosure, as long as the perturbation is local, i.e., within the interval. In the above embodiment, the processing unit 101 performs isospectral processing on the input signal, which means that the processing unit 101 performs a spectrum adjustment on the input perturbation signal or the input isoprobabilistic signal, so that the spectrum of the input signal after adjustment has a smaller a spectra difference with the target spectrum than the spectrum of the input signal before adjustment, and the signal after adjustment is an isospectral signal. The spectra difference is measured at a certain spectral resolution, but no comparison is made for the fine structure difference within the spectral resolution. In addition, when the input signal is an isoprobabilistic signal, firstly the processing unit 101 performs time-frequency domain transform on the input signal to transform the input signal from time domain to frequency domain, and then performs a spectrum adjustment.

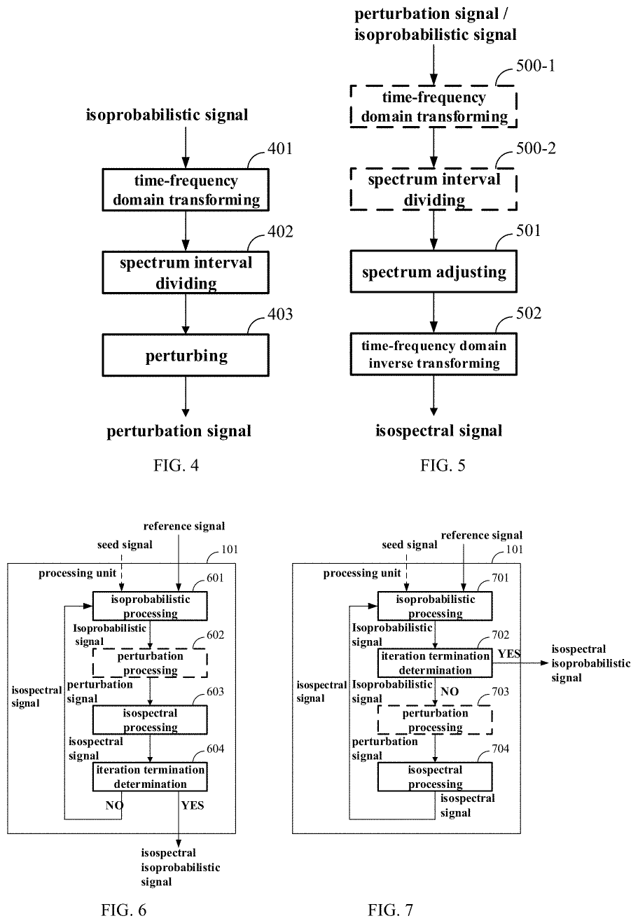

FIG. 5 is a schematic diagram of isospectral processing. As illustrated in FIG. 5, the isospectral processing includes spectrum adjusting 501 and time-frequency domain inverse transforming 502.

In the spectrum adjusting 501, the processing unit 101 performs spectrum adjustment on the input signal (a perturbation signal or an isoprobabilistic signal) so that a spectra difference between a spectrum of the input signal after adjustment and the target spectrum is less than a spectra difference between a spectrum of the input signal before adjustment and the target spectrum. That is, a spectra difference between the adjusted signal and the target spectrum is less than a spectra difference between the unadjusted signal and the target spectrum. If the input signal is an isoprobabilistic signal, time-frequency domain transforming (500-1) is performed on the input signal, and spectrum interval dividing (500-2) is performed on the transformed signal, then the spectrum adjusting 501 is performed. The specific processing is the same as the time-frequency domain transforming 401 and the spectrum interval dividing 402 in the example of FIG. 4, which will not be repeated here.

In the above embodiment, the spectrum adjustment can take the resolution bandwidth as granularity, that is, only the total power of the resolution bandwidth is changed, and the fine structure within the resolution bandwidth is not changed.

In some embodiments, the spectrum adjustment may be one-step adjustment to the target spectrum. For example, the spectrum adjustment is performed according to a formula below:

$${P}_{m , n}^{Nor} = {P}_{m , n}^{′} \times sqrt ( \frac{{Power}_{m}}{{\sum }_{i = 1}^{N} {\vert {P}_{m , n}^{′} \vert}^{2}} )$$

where P_{m,n}^{Nor} denotes an n-th spectral line in an m-th interval after spectrum adjustment, and POWERₘ denotes the total power of the target spectrum in the m-th interval.

In some embodiments, the spectrum adjustment may also be gradual.

For example, when the target spectrum is a notched signal and it is assumed that the spectral line Pᵢ^{Nor}|_{aslab} is within a target notched frequency range, the spectrum adjustment may be expressed as:

Pᵢ^{Narch}|_{aslab}β×Pᵢ^{Nor}|_{aslab}

where β is an adjustment coefficient, which may be 0 or any other value greater than 0 and less than 1. When β is valued as 0, it indicates one-step adjustment to the target notched signal, and when β takes a value other than 0, it indicates a gradual adjustment. In addition, it should be noted that for a real signal, positive and negative frequency components of its signal spectrum are symmetrical with respect to the zero frequency, so it is necessary to perform the same spectrum adjustment processing on the positive and negative frequency components.

For another example, when the target spectrum is a notched signal containing K notched frequency bands and it is assumed that the spectral line Pᵢ^{Nor}|_{akslabk}(k=1,2, . . . , K) is within in a k-th notched frequency band of the target spectrum, the spectrum adjustment may be expressed as:

Pᵢ^{Natch}|aslab=β×Pᵢ^{Nor}|_{aslab}

where β is an adjustment coefficient, which may be 0 or any other value greater than 0 and less than 1. When β is valued as 0, it indicates one-step adjustment to the target notched signal, and when β takes a value other than 0, it indicates a gradual adjustment. In addition, it should also be noted that for a real signal, positive and negative frequency components of its signal spectrum are symmetrical with respect to the zero frequency, so it is necessary to perform the same spectrum adjustment processing on the positive and negative frequency components.

For example, when the target spectrum is a band-pass signal and the spectral line Rᵢ^{Nor}|_{1<α or 1>b} is outside the passband, the spectrum adjustment may be expressed as:

Pᵢ^{Band-Pass}|_{1<α or 1>b}β×Pᵢ^{Nor}|_{1<α or 1>b}

where β is an adjustment coefficient, which may be 0 or any other value greater than 0 and less than 1.

The spectrum adjusting 501 is described through the above examples, but it is not limited in the present disclosure. When the target spectrum is any other type of signal, the spectrum adjustment may be performed by analogy according to the above examples, which will not be repeated here.

In the time-frequency domain inverse transforming 502, the processing unit 101 transforms the signal after spectrum adjustment from frequency domain back to time domain, and performs a real part taking operation on the obtained signal, that is, only a real part of the transformed signal is retained, and the retained real part is an isospectral signal. The specific transform mode may refer to the related art, which is omitted here.

In the embodiment of the present disclosure, after the isoprobabilistic processing, perturbation processing (optional) and isospectral processing are performed on the input signal by the processing unit 101, the processing unit 101 further performs iteration termination determination to determine whether the obtained signal satisfies both a requirement on a target probability distribution and a requirement on a target spectrum; and if it is determined to be yes, terminates the processing; otherwise, proceeds with the isoprobabilistic processing, the perturbation processing (optional) and the isospectral processing, so as to finally obtain a signal that satisfies both the requirement on the target probability distribution and the requirement on the target spectrum through cyclic iterations. In the embodiment of the present disclosure, the target probability distribution may be a continuous real variable, a discrete real variable, a continuous complex variable or a discrete complex variable, which is described below respectively.

FIG. 6 is a schematic diagram of an implementation of the processing unit 101 when the target probability distribution is a continuous real variable. As illustrated in FIG. 6, the processing performed by the processing unit 101 includes isoprobabilistic processing 601, perturbation processing 602 (optional), isospectral processing 603 and iteration termination determination 604. The iteration termination determination 604 follows the isospectral processing 603. The isoprobabilistic processing 601, the perturbation processing 602 and the isospectral processing 603 have been described previously and will not be repeated here. In the iteration termination determination 604, the processing unit 101 determines whether an iteration termination condition is satisfied; terminates the iteration if the iteration termination condition is satisfied (determined as Yes), and takes an isospectral signal obtained by the isospectral processing 603 as a signal that satisfies the requirement on the target probability distribution and the requirement on the target spectrum; and proceeds with the iteration cycle process if the iteration termination condition is not satisfied (determined as No), and takes the isospectral signal obtained by the isospectral processing 603 as the input signal of the isoprobabilistic processing 601.

In the above embodiment, the iteration termination condition may be that a difference between the isospectral signal and the target probability distribution is less than a preset threshold (called as a PDF difference threshold). That is, the processing unit 101 determines whether a difference (PDF difference) between the isospectral signal and the target probability distribution is less than a preset threshold, and if it is determined to be yes, terminates the iteration, otherwise proceeds with the iteration cycle process.

In some embodiments, the calculation formula of the PDF difference is as follows:

$$PDF difference = \frac{1}{2} \int \vert {P}_{1} ( i ) - {P}_{2} ( i ) \vert , \int {P}_{1} ( i ) = 1 , \int {P}_{2} ( i ) = 1$$

where P₁(t) denotes a probability density distribution of an amplitude i in the isospectral signal, and P₂(i) denotes a probability density distribution of the amplitude i in the target probability distribution. The PDF difference is valued between 0 and 1, wherein the PDF difference is 0 when the probability density distribution P₁(i) of the isospectral signal is exactly the same as the target P₂(i); and the PDF difference is 1 when the probability density distribution Pᵢ(t) of the isospectral signal is completely different from the target P₂(i).

In the above embodiment, the value of the PDF difference threshold is not limited. For example, the PDF difference threshold may be set as 0.015, or any other value as needed.

FIG. 7 is a schematic diagram of another implementation of the processing unit 101 when the target probability distribution is a continuous real variable. Being different from the implementation of FIG. 6, in the implementation of FIG. 7, the iteration termination determination 702 follows the isoprobabilistic processing 701. As illustrated in FIG. 7, the processing performed by the processing unit 101 includes: isoprobabilistic processing 701, iteration termination determination 702, perturbation processing 703 (optional) and isospectral processing 704. The isoprobabilistic processing 701, the perturbation processing 703 and the isospectral processing 704 have been described previously and will not be repeated here.

In the iteration termination determination 702, the processing unit 101 determines whether an iteration termination condition is satisfied; terminates the iteration if the iteration termination condition is satisfied (determined as Yes), and takes an isoprobabilistic signal obtained by the isoprobabilistic processing 701 as a signal that satisfies the requirement on the target probability distribution and the requirement on the target spectrum; and proceeds with the iteration cycle process if the iteration termination condition is not satisfied (determined as No), and takes the isoprobabilistic signal obtained by the isoprobabilistic processing 701 as the input signal of the isospectral processing 704 or the perturbation processing 703.

In the above embodiment, as illustrated in FIG. 7, after the isospectral processing 704, the processing unit 101 feeds back the isospectral signal obtained by the isospectral processing to the isospectral processing 701 as an input signal in a next iteration. In the above embodiment, when the target spectrum distribution is a notched signal (including one or more notched frequency bands), the iteration termination condition may be that all notched depths of the isoprobabilistic signal are greater than a preset threshold (called as a notched depth threshold). That is, the processing unit 101 determines whether all notched depths of the generated isoprobabilistic signal are greater than a certain threshold. If it is determined to be yes, the iteration cycle is terminated, and the isoprobabilistic signal generated in the previous step is an isospectral isoprobabilistic signal that satisfies the target requirements. If it is determined to be not, the iteration cycle process is proceeded with, and the generated isoprobabilistic signal is sent to the perturbation processing 703 process or the isospectral processing 704 process. In the above embodiment, the value of the notched depth threshold is not limited. For example, the notched depth threshold may be set as 30 dB, or any other value as needed.

In the above embodiment, when the target spectrum is a band-pass signal, the iteration termination condition may be that a signal-to-noise ratio of the isoprobabilistic signal is greater than a preset threshold (called as a signal-to-noise ratio threshold). That is, the processing unit 101 determines whether the signal-to-noise ratio of the isoprobabilistic signal is greater than a certain threshold. If it is determined to be yes, the iteration cycle is terminated, and the isoprobabilistic signal generated in the previous step is an isospectral isoprobabilistic signal that satisfies the target requirements. If it is determined to be not, the iteration cycle process is proceeded with, and the generated isoprobabilistic signal is sent to the perturbation processing 703 process or the isospectral processing 704 process. In the above embodiment, the value of the signal-to-noise ratio threshold is not limited. For example, the signal-to-noise ratio threshold may be set as 30 dB, or any other value as needed.

In the above embodiment, when the target spectrum is another type of spectrum distribution, the iteration termination condition may be that a spectra difference between the isoprobabilistic signal and the target spectrum is less than a preset threshold (called as a spectra difference threshold). That is, the processing unit 101 determines whether a spectra difference between the isoprobabilistic signal and the target spectrum distribution is lower than a certain threshold. The calculation formula of the spectra difference is as follows:

$$Spectra difference = \frac{1}{2} {\sum }_{freq} \vert {S}_{1} ( i ) - {S}_{2} ( i ) \vert / {\sum }_{freq} \vert {S}_{2} ( i ) \vert , {\sum }_{freq} \vert {S}_{1} ( i ) \vert = {\sum }_{freq} \vert {S}_{2} ( i ) \vert$$

where R₁(l) and R₂(t) denote Power Spectrum Densities (PSDs) of the isoprobabilistic signal and the target signal, respectively, and Σ_{frea}|S₁(i)|=Σ_{frea}|S₂(t)| indicates that the total power of the isoprobabilistic signal and the total power of the target signal should be equal to each other during the calculation of the spectra.

The value of the spectra difference threshold is not limited. For example, the spectra difference threshold may be set as 0.02, or any other value as needed.

The processing performed by the processing unit 101 when the target probability distribution is a continuous real variable has been described above by taking FIGS. 6 and 7 as examples. In the embodiment of the present disclosure, when the target probability distribution is a discrete real variable, such as a standard PAM 8 signal symbol sequence, the processing unit 101 may firstly perform diffusion processing on the reference signal and then perform subsequent processing.

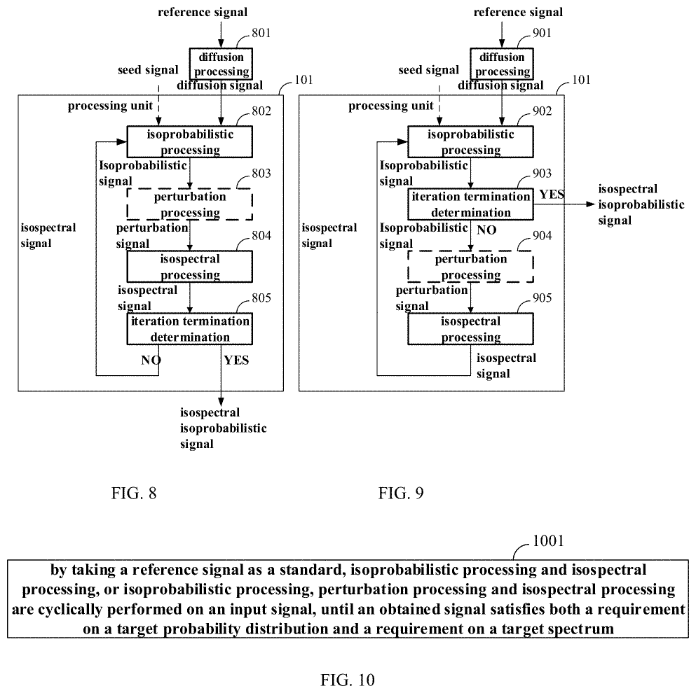

FIG. 8 is a schematic diagram of an implementation of the processing unit 101 when the target probability distribution is a discrete real variable. As illustrated in FIG. 8, being different from the example of FIG. 6, the reference signal is discrete, on which diffusion processing is performed by the processing unit 101, and takes the obtained diffusion signal as the reference signal. As illustrated in FIG. 8, the processing performed by the processing unit 101 includes diffusion processing 801, isoprobabilistic processing 802, perturbation processing 803 (optional), isospectral processing 804, and an iteration termination determination 805. The isoprobabilistic processing 802, the perturbation processing 803 and the isospectral processing 804 have been described previously and will not be repeated here.

In the diffusion processing 801, the processing unit 101 performs diffusion processing on the discrete reference signal, converts the discrete reference signal into a continuously distributed diffusion signal, and replaces the reference signal with the diffusion signal.

In the above embodiment, since the discrete random variables include many samples with the same value, ambiguity occurs in the sorting, and the discrete random variables cannot be directly used by the isoprobabilistic processing. In order to avoid the problem of sorting ambiguity, the embodiment of the present disclosure changes the discrete reference signal into a continuously distributed diffusion signal by performing diffusion processing on the discrete reference signal, and replaces the original reference signal with the diffusion signal to perform the subsequent isoprobabilistic processing.

In the above embodiment, the diffusion processing 801 may be expressed as:

Sₐ=S_{ref}δₐ

where Sₐ, S_{ref} and δₐ denote a diffusion signal, an original discrete reference signal and a diffusion component, respectively. The diffusion component may be any continuously distributed variable with a mean value of zero, and the magnitude of the diffusion component is denoted by its standard deviation std(δₐ). The conventional diffusion distribution is a Gaussian distribution, but an even distribution or other types of distribution may also be adopted, which is not limited in the present disclosure. In the above embodiment, the magnitude of the diffusion component (i.e., the standard deviation) is not specifically limited, and it may be reasonably selected according to the actual situation. For example, a method of diffusion processing is to gradually reduce the magnitude of the diffusion component during iteration, that is, the diffusion processing may be varied, and the diffusion component contained in the diffusion signal gradually decreases as the iteration progresses. Therefore, the probability density distribution of the finally obtained isospectral isoprobabilistic signal may be the same as that of the diffusion signal with a small diffusion component, thus being closer to the distribution of the original discrete reference signal.

The method of determination of the processing unit 101 in the iteration termination determination 805 in the same as the iteration termination determination 604 of FIG. 6. That is, the processing unit 101 determines whether an iteration termination condition is satisfied; terminates the iteration if the iteration termination condition is satisfied, and takes an isospectral signal obtained by the isospectral processing as a signal that satisfies the requirement on the target probability distribution and the requirement on the target spectrum; and continues the iteration cycle process if the iteration termination condition is not satisfied, and takes the isospectral signal obtained by the isospectral processing as the input signal of the isoprobabilistic processing.

Being different from the iteration termination determination 604 of FIG. 6, in the iteration termination determination 805, the iteration termination condition is that a difference between the isospectral signal and the target probability distribution is less than a preset threshold, and a diffusion component contained in the diffusion signal is less than a preset threshold (called as a diffusion component threshold). That is, based on the iteration termination condition of FIG. 6, it is also required that the diffusion component of the diffusion signal at this time is already less than a preset threshold. The diffusion component means the degree of isoprobability, which depends on the specific requirements on the problem to be solved, and it is not limited in the present disclosure.

FIG. 9 is a schematic diagram of another implementation of the processing unit 101 when the target probability distribution is a discrete real variable. Being different from the implementation of FIG. 8, in the implementation of FIG. 9, the iteration termination determination 903 follows the isoprobabilistic processing 902. As illustrated in FIG. 9, the processing performed by the processing unit 101 includes diffusion processing 901, isoprobabilistic processing 902, iteration termination determination 903, perturbation processing 904 (optional) and isospectral processing 905. The diffusion processing 901, the isoprobabilistic processing 902, the perturbation processing 904 and the isospectral processing 905 have been described previously and will not be repeated here.

The method of determination of the processing unit 101 in the iteration termination determination 903 is the same as the iteration termination determination 702 of FIG. 7. That is, the processing unit 101 determines whether an iteration termination condition is satisfied;

terminates the iteration if the iteration termination condition is satisfied, and takes an isoprobabilistic signal obtained by the isoprobabilistic processing as a signal that satisfies the requirement on the target probability distribution and the requirement on the target spectrum; and proceeds with the iteration cycle process if the iteration termination condition is not satisfied, and takes the isoprobabilistic signal obtained by the isoprobabilistic processing as the input signal of the isospectral processing or the perturbation processing.

In addition, in the iteration termination determination 903, the processing unit 101 further feeds back the isospectral signal obtained by the isospectral processing 905 to the isoprobabilistic processing 902 as an input signal in a next iteration. Being different from the iteration termination determination 702 of FIG. 7, in the iteration termination determination 903, the iteration termination condition further includes that the diffusion component contained in the diffusion signal is less than a preset threshold, in addition to the iteration termination condition in the example of FIG. 7.

That is, if the distribution of the target spectrum is a notched signal, the iterative termination condition is that a notched depth of the isoprobabilistic signal is greater than a preset threshold (notched depth threshold), and the diffusion component contained in the diffusion signal is less than a preset threshold (diffusion component threshold). If the distribution of the target spectrum is a notched signal containing multiple notched frequency bands, the iterative termination condition is that the notched depths of all notched frequency bands of the isoprobabilistic signal are greater than a preset threshold (notched depth threshold), and the diffusion component contained in the diffusion signal is less than a preset threshold (diffusion component threshold). If the distribution of the target spectrum is a band-pass signal, the iteration termination condition is that a signal-to-noise ratio of the isoprobabilistic signal is greater than a preset threshold (signal-to-noise ratio threshold), and the diffusion component contained in the diffusion signal is less than a preset threshold (diffusion component threshold). If the distribution of the target spectrum is another type of spectrum distribution than the notched signal and the band-pass signal, the iteration termination condition is that a spectra difference between the isoprobabilistic signal and the target spectrum is less than a preset threshold (spectra difference threshold), and the diffusion component contained in the diffusion signal is less than a preset threshold (diffusion component threshold). The diffusion component thresholds may be the same or different for different target spectrum distributions, which is not limited in the present disclosure.

In the examples of FIGS. 8 and 9, a signal directly obtained after the iteration, i.e., an isospectral isoprobabilistic signal, also contains a certain diffusion component, and the signal may be directly used as an approximation of the isospectral isoprobabilistic target signal, or it may be quantized into a corresponding discrete signal for use.

For example, when the target probability distribution is a PAM8 symbol sequence, the reference signal is also a PAM8 symbol sequence, and the diffusion signal is a PAM8 signal containing a diffusion component. The signal generated by the example of FIG. 8 or FIG. 9 is a signal having the same probability density distribution as the diffusion signal, and it can be directly used, or quantized into a standard PAM8 symbol for use. A method using the two kinds of signal may be reasonably selected as needed, which is not limited in the present disclosure.

The processing performed by the processing unit 101 when the target probability distribution is a continuous or discrete complex variable has been described above by taking FIGS. 6 to 9 as examples. In the embodiment of the present disclosure, when the target probability distribution is a continuous or discrete complex variable, it is impossible to directly apply the above processing process because the complex signal has no magnitude and cannot be sorted. Therefore, in the embodiment of the present disclosure, the processing unit 101 may separately process an I-branch and a Q-branch of a complex target signal according to the above real signal generation process. In addition, in order to ensure that an obtained I-branch signal and an obtained Q-branch signal are independent of each other, seed signals adopted by the branches during the signal generation are independent of and different from each other. Finally, the obtained I-branch signal and the obtained Q-branch signal are combined to obtain a complex signal that satisfies the requirement on the specific probability distribution and the requirement on the spectrum.

For example, by taking the reference signal as a standard, the processing unit 101 may cyclically perform isoprobabilistic processing and isospectral processing respectively, or cyclically perform isoprobabilistic processing, perturbation processing and isospectral processing respectively, on an I-branch and a Q-branch of the input signal, until an obtained I-branch signal and an obtained Q-branch signal respectively satisfy the requirement on the target probability distribution and the requirement on the target spectrum; and combine the obtained signal of the I branch and the obtained Q-branch signal to obtain a complex signal that satisfies the requirement on the target probability distribution and the requirement on the target spectrum.

In the above embodiment, the requirement on the target probability distribution is given in the form of an I-branch reference signal and a Q-branch reference signal respectively, that is, the target probability distribution is provided by I-branch reference signal and

Q-branch reference signal respectively, and the probability distributions of I-branch reference signal and Q-branch reference signal are the same as a real part and an imaginary part required by the target probability distribution.

In the above embodiments, the isoprobabilistic processing, the perturbation processing, the isospectral processing and the iteration termination condition have been described above and will not be repeated here.

It should be noted that the above FIGS. 2 to 9 only schematically illustrate the embodiments of the present disclosure, but the present disclosure is not limited thereto. For example, each processing may be adjusted appropriately, and other processing may be added or some of the processing may be reduced. Those skilled in the art can make appropriate modifications according to the above contents, rather than being limited to FIGS. 2 to 9.

Those described above just exemplarily illustrate the embodiments of the present disclosure, and the present disclosure is not limited thereto. Appropriate modifications can be made based on the above embodiments. For example, the above embodiments may be adopted separately, or one or more of them may be combined.

According to the embodiments of the present disclosure, by adopting a process of cyclically performing isoprobabilistic processing and isospectral processing or a process of cyclically performing isoprobabilistic processing, perturbation processing and isospectral processing, a signal that satisfies both a requirement on a specific probability distribution and a requirement on a spectrum can be generated, and the degree of compliance is higher compared with the related art. In addition, the present disclosure has no limitation on the type of the probability distribution of the target signal, which may be a continuous variable, a discrete variable, a real variable or a complex variable.

Embodiments of a Second Aspect

The embodiments of the present disclosure provide a method for generating a signal. Since the principles of this method for solving problems are similar to that of the apparatus according to the embodiments of the first aspect, its specific implementations may refer to those of the apparatus according to the embodiments of the first aspect, and the same content will not be repeated.

FIG. 10 is a schematic diagram of an implementation of a method for generating a signal according to an embodiment of the present disclosure. As illustrated in FIG. 10, the method includes:

1001: by taking a reference signal as a standard, isoprobabilistic processing and isospectral processing, or isoprobabilistic processing, perturbation processing and isospectral processing are cyclically performed on an input signal, until an obtained signal satisfies both a requirement on a target probability distribution and a requirement on a target spectrum.

In some embodiments, the probability distribution of the input signal at a first time of iteration is arbitrary.

In some embodiments, the isoprobabilistic processing includes: amplitude sorting, in which the input signal and the reference signal are sorted respectively according to amplitudes of their respective data sample points, and temporal position coordinates of the sorted data sample points of the input signal in an original signal sequence are recorded;

amplitude replacing, in which amplitudes of the sorted data sample points of the input signal are replaced with amplitudes of the sorted data sample points of the reference signal; and

time sorting, in which all data sample points of the input signal with the amplitude replaced are resorted according to recorded temporal position coordinates, so as to obtain an isoprobabilistic signal.

In some embodiments, the isoprobabilistic processing includes:

position locking, in which all data sample points in the input signal and reference signal at required temporal positions are locked, so that they do not participate in a subsequent process of isoprobabilistic processing;

amplitude sorting, in which other data sample points in the input signal and the reference signal are sorted respectively according to the amplitudes of data sample points, and temporal position coordinates of the other sorted data sample points of the input signal in the original signal sequence are recorded;

amplitude replacing, in which amplitudes of the other sorted data sample points of the input signal are replaced with amplitudes of the other sorted data sample points of the reference signal; and

time sorting, in which all data sample points of the input signal with the amplitudes replaced are resorted according to the recorded temporal position coordinates, so as to obtain an isoprobabilistic signal.

In some embodiments, the perturbation processing includes:

time-frequency domain transforming, in which the input signal is transformed from time domain to frequency domain;

spectral interval dividing, in which the entire spectrum of the input signal is divided into multiple frequency intervals; and

perturbation processing, in which perturbation is performed on frequency components of the input signal in the frequency intervals so as to change fine structures of spectral lines in the frequency intervals, thereby obtaining a perturbation signal.

The perturbation processing includes coordination perturbation, that is, the frequency intervals are divided at equal intervals, identical perturbation processing is performed on all the frequency intervals, and a coordination perturbation process performed in a former iteration and a coordination perturbation process performed in a latter iteration are independent of each other.

In some embodiments, the isospectral processing includes:

spectrum adjusting, in which spectrum adjustment is performed on the input signal so that a difference between a spectrum of the input signal after adjustment and a target spectrum is less than a difference between a spectrum of the input signal before adjustment and the target spectrum; and

time-frequency domain inverse transforming, in which the signal with the spectrum adjusted is transformed from frequency domain back to time domain, and real part taking operation is performed on the obtained signal so as to obtain an isospectral signal.

In some embodiments, the target probability distribution is a continuous real variable.

In the above embodiment, after the isospectral processing, the method further includes:

determining whether an iteration termination condition is satisfied;

terminating the iteration if the iteration termination condition is satisfied, and taking the isospectral signal obtained by the isospectral processing as a signal that satisfies the requirement on the target probability distribution and the requirement on the target spectrum; and

proceeding with the iteration cycle process if the iteration termination condition is not satisfied, and taking the isospectral signal obtained by the isospectral processing as the input signal of the isoprobabilistic processing.

The iteration termination condition is that a difference between the isospectral signal and the target probability distribution is less than a preset threshold.

In the above embodiment, after the isoprobabilistic processing, the method further includes:

determining whether an iteration termination condition is satisfied;

terminating the iteration if the iteration termination condition is satisfied, and taking the isoprobabilistic signal obtained by the isoprobabilistic processing as a signal that satisfies the requirement on the target probability distribution and the requirement on the target spectrum; and

proceeding with the iteration cycle process if the iteration termination condition is not satisfied, and taking the isoprobabilistic signal obtained by the isoprobabilistic processing as the input signal of the isospectral processing or perturbation processing.

After the isospectral processing, the signal obtained by the isospectral processing is fed back to the isoprobabilistic processing as an input signal in a next iteration.

In which,

if the distribution of the target spectrum is a notched signal, the iteration termination condition is that a notched depth of the isoprobabilistic signal is greater than a preset threshold;

if the distribution of the target spectrum is a notched signal containing multiple notched frequency bands, the iteration termination condition is that notched depths of all notched frequency bands of the isoprobabilistic signal are greater than a preset threshold;

if the distribution of the target spectrum is a band-pass signal, the iteration termination condition is that a signal-to-noise ratio of the isoprobabilistic signal is greater than a preset threshold;

if the distribution of the target spectrum is another type of spectral distribution than the notched signal and the band-pass signal, the iteration termination condition is that a spectral difference between the isoprobabilistic signal and the target spectrum is lower than a preset threshold.

In some embodiments, the target probability distribution is a discrete real variable, the reference signal is a discrete reference signal, and the method further includes:

performing diffusion processing on the discrete reference signal, converting the discrete reference signal into a continuously distributed diffusion signal, and replacing the reference signal with the diffusion signal.

In the above embodiment, the diffusion processing is variable, that is, as the iteration process progresses, a diffusion component contained in the diffusion signal gradually decreases.

In the above embodiment, after the isospectral processing, the method further includes:

determining whether an iteration termination condition is satisfied; terminating the iteration if the iteration termination condition is satisfied, and taking the isospectral signal obtained by the isospectral processing as a signal that satisfies the requirement on the target probability distribution and the requirement on the target spectrum; and

proceeding with the iteration cycle process if the iteration termination condition is not satisfied, and taking the isospectral signal obtained by the isospectral processing as the input signal of the isoprobabilistic processing.

The iteration termination condition is that a difference between the isospectral signal and the target probability distribution is less than a preset threshold, and a diffusion component contained in the diffusion signal is less than a preset threshold.

In the above embodiment, after the isoprobabilistic processing, the method further includes:

determining whether an iteration termination condition is satisfied;

terminating the iteration if the iteration termination condition is satisfied, and taking the isoprobabilistic signal obtained by the isoprobabilistic processing as a signal that satisfies the requirement on the target probability distribution and the requirement on the target spectrum; and

proceeding with the iteration cycle process if the iteration termination condition is not satisfied, and taking the isoprobabilistic signal obtained by the isoprobabilistic processing as the input signal of the isospectral processing or the perturbation processing.

After the isospectral processing, the signal obtained by the isospectral processing is fed back to the isoprobabilistic processing as an input signal in a next iteration.

In which,

if the distribution of the target spectrum is a notched signal, the iteration termination condition is that a notched depth of the isoprobabilistic signal is greater than a preset threshold, and a diffusion component contained in the diffusion signal is less than a preset threshold;

if the distribution of the target spectrum is a notched signal containing multiple notched frequency bands, the iteration termination condition is that notched depths of all notched frequency bands of the isoprobabilistic signal are greater than a preset threshold, and a diffusion component contained in the diffusion signal is less than a preset threshold;

if the distribution of the target spectrum is a band-pass signal, the iteration termination condition is that a signal-to-noise ratio of the isoprobabilistic signal is greater than a preset threshold, and a diffusion component contained in the diffusion signal is less than a preset threshold; and

if the distribution of the target spectrum is another type of spectral distribution than the notched signal and the band-pass signal, the iteration termination condition is that a spectral difference between the isoprobabilistic signal and the target spectrum is lower than a preset threshold, and a diffusion component contained in the diffusion signal is less than a preset threshold.

In some embodiments, the target probability distribution is a continuous or discrete complex variable, and the method includes:

taking the reference signal as a standard, cyclically performing isoprobabilistic processing and isospectral processing, or cyclically performing isoprobabilistic processing, perturbation processing and isospectral processing, on an I-branch and a Q-branch of the input signal respectively, until an obtained I-branch signal and an obtained Q-branch signal respectively satisfy the requirement on the target probability distribution and the requirement on the target spectrum; and combining the obtained I-branch signal and the obtained Q-branch signal to obtain a complex signal that satisfies the requirement on the target probability distribution and the requirement on the target spectrum.

Those described above just exemplarily illustrate the embodiments of the present disclosure, and the present disclosure is not limited thereto. Appropriate modifications can be made based on the above embodiments. For example, the above embodiments may be adopted separately, or one or more of them may be combined.

According to the embodiments of the present disclosure, by adopting a process of cyclically performing isoprobabilistic processing and isospectral processing or a process of cyclically performing isoprobabilistic processing, perturbation processing and isospectral processing, a signal that satisfies both a requirement on a specific probability distribution and a requirement on a spectrum can be generated, and the degree of compliance is higher compared with the related art. In addition, the present disclosure has no limitation on the probability distribution type of the target signal, which may be a continuous variable, a discrete variable, a real variable or a complex variable.

Embodiments of a Third Aspect

The embodiments of the present disclosure provide a measurement system of a nonlinear system.

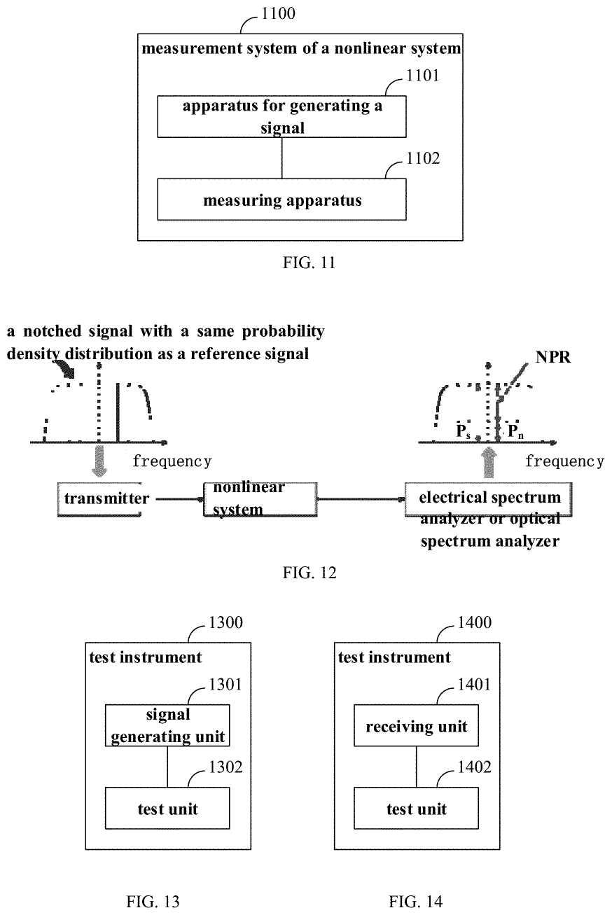

FIG. 11 is a schematic diagram of an example of a measurement system 100 of a nonlinear system according to an embodiment of the present disclosure.

As illustrated in FIG. 11, the measurement system 1100 includes an apparatus 1101 for generating a signal and a measuring apparatus 1102; the apparatus 1101 for generating a signal is configured to generate a target signal and may be implemented by the apparatus 100 for generating a signal according to the embodiments of the first aspect. Since the apparatus 100 for generating a signal has been described in detail in the embodiments of the first aspect, its content is incorporated here and will not be repeated. The measuring apparatus 1102 is configured to measure nonlinear characteristics of the nonlinear system according to the target signal.

FIG. 12 is a schematic diagram of a working flow of a measurement system 1100 of a nonlinear system according to an embodiment of the present disclosure. As illustrated in FIG. 12, the measurement system 1100 according to the embodiment of the present disclosure may measure nonlinear characteristics of a nonlinear system by using an isoprobabilistic notch test input signal (a notched signal with a same probability density distribution as a reference signal).

For example, in order to test the magnitude of nonlinear noise of a PAM signal passed through a nonlinear system to be tested, the method according to the embodiments of the second aspect (using the apparatus according to the embodiments of the first aspect) is adopted to generate a notch test signal with a same probability density distribution as the PAM signal, and input the notch test signal into the nonlinear system to be tested. Thus, a newly generated frequency component may be observed at a notched frequency position of an output signal of the nonlinear system, which is caused by a nonlinear effect, and the average power of the newly generated frequency component may be denoted as Pₙ; the average power of the signal adjacent to the notched part may be denoted as Pₛ. Thus, the magnitude of the nonlinear noise of the PAM signal passed through the nonlinear system may be expressed by a nonlinear Noise Power Ratio, NPR), that is, NPR=Pₙ/(Pₛ-Pₙ).

In the above embodiment, when a transmitter is an electric transmitter (e.g., a radio frequency transmitter), a test device for acquiring a spectrum of the output signal of the nonlinear system may be an Electrical Spectrum Analyzer (ESA). When the transmitter is an optical transmitter, the test device for acquiring the spectrum of the output signal of the nonlinear system may be an Optical Spectrum Analyzer (OSA). The electrical spectrum analyzer or the optical spectrum analyzer may be selected as needed to acquire the spectrum of the output signal of the nonlinear system.

It should be noted that the measurement system of the nonlinear system according to the embodiments of the present disclosure is not limited to measuring the nonlinear noise of the PAM signal passed through the nonlinear system to be measured, and it is also applicable to signals of other modulation formats, such as a Probability Shaping (PS) signal, which is not limited in the present disclosure.

The embodiments of the present disclosure further provide a test instrument.

FIG. 13 is a schematic diagram of an example of a test instrument according to an embodiment of the present disclosure. As illustrated in FIG. 13, the test instrument 1300 includes a signal generating unit 1301 and a test unit 1302, wherein the signal generating unit 1301 is configured to generate a target signal, the signal generating unit 1301 may be implemented by the apparatus 100 for generating a signal according to the embodiments of the first aspect; since the apparatus 100 for generating a signal has been described in detail in the embodiments of the first aspect, its content is incorporated here and will not be repeated; the test unit 1302 is configured to perform test according to the target signal.

For example, an apparatus and method for generating a signal that satisfies a requirement on a specific probability distribution and a requirement on a spectrum may be built in the test instrument 1300, and the test instrument 1300 may generate a specific test input signal according to a specific test task.

FIG. 14 is a schematic diagram of another example of a test instrument according to an embodiment of the present disclosure. As illustrated in FIG. 14, the test instrument 1400 includes a receiving unit 1401 and a test unit 1402, wherein the receiving unit 1401 is configured to receive a target signal, the target signal being generated by the apparatus 100 for generating a signal according to the embodiments of the first aspect; since the apparatus 100 for generating a signal has been described in detail in the embodiments of the first aspect, its content is incorporated here and will not be repeated; the test unit 1402 is configured to perform test according to the target signal. For example, the test instrument 1400 may directly receive the generated test signal that satisfies the requirement on the specific probability distribution and the requirement on the spectrum.

According to the embodiment of the present disclosure, a signal that satisfies both a requirement on a specific probability distribution and a requirement on a spectrum can be generated, and the degree of compliance is higher compared with the related art. Therefore, the NPR measurement result is more accurate, and the nonlinearity of the system to be tested can be evaluated more accurately.

The embodiments of the present disclosure further provide a computer-readable program, wherein when being executed in an apparatus for generating a signal, the program causes the apparatus for generating a signal to perform the method according to the embodiments of the second aspect.

The embodiments of the present disclosure provide a storage medium in which a computer-readable program is stored, wherein the computer-readable program causes an apparatus for generating a signal to perform the method according to the embodiments of the second aspect.

The above devices and methods of the present disclosure may be implemented by hardware or a combination of hardware and software. The present disclosure relates to a computer-readable program which, when being executed by a logic unit, enables the logic unit to implement the above devices or constituent parts, or enables the logic unit to implement the above methods or steps. The present disclosure also relates to a storage media storing the above program, such as a hard disk, a magnetic disk, an optical disk, a DVD, a flash memory, etc.

The methods/devices described in conjunction with the embodiments of the present disclosure may be directly embodied as hardware, a software module executed by a processor, or a combination thereof. For example, one or more of the functional block diagrams illustrated in the drawings and/or one or more combinations of the functional block diagrams may correspond to either respective software modules or respective hardware modules of a computer program flow. The software modules may respectively correspond to the steps illustrated in the drawings. The hardware modules for example may be implemented by solidifying the software modules with a field programmable gate array (FPGA).

The software module may be located in an RAM memory, a flash memory, an ROM memory, an EPROM memory, an EEPROM memory, a register, a hard disk, a removable disk, a CD-ROM or any other form of storage medium known in the art. A storage medium may be coupled to a processor, so that the processor can read information from and write information to the storage medium. Or, the storage medium may be a constituent part of the processor. The processor and the storage medium may be in an ASIC. The software module may be stored in a memory of a mobile terminal, or in a memory card insertable into the mobile terminal. For example, if a device (such as a mobile terminal) adopts a large-capacity MEGA-SIM card or a large-capacity flash memory device, the software module may be stored in the large-capacity MEGA-SIM card or the large-capacity flash memory device.

One or more of the functional blocks described in the drawings and/or one or more combinations of the functional blocks may be implemented as a general-purpose processor, a digital signal processor (DSP), an application specific integrated circuit (ASIC), a field programmable gate array (FPGA) or any other programmable logic device, discrete gates or transistor logic devices, discrete hardware components or any suitable combination thereof, for performing the functions described in the present disclosure. One or more of the functional blocks described in the drawings and/or one or more combinations of the functional blocks may further be realized as a combination of computing devices, such as a combination of a DSP and a microprocessor, a plurality of microprocessors, one or more microprocessors in communication with the DSP, or any other such configuration.

The present disclosure has been described above in conjunction with the specific implementations, but those skilled in the art should understand that these descriptions are exemplary rather than limiting the protection scope of the present disclosure. Those skilled in the art can make various variations and modifications to the present disclosure according to the spirit and principle of the present disclosure, and these variations and modifications should also fall within the scope of the present disclosure.

1. An apparatus comprising:
a memory; and
a processor coupled to the memory, the processor to control execution of a process including:
by taking a reference signal as a standard, cyclically perform isoprobabilistic processing and isospectral processing, or cyclically perform isoprobabilistic processing, perturbation processing and isospectral processing, on an input signal, until an obtained signal satisfies both a requirement on target probability distribution and a requirement on a target spectrum, where a probability distribution of the reference signal satisfies the requirement on target probability distribution,
wherein the isoprobabilistic processing refers to a processing that makes the probability distribution of an output signal identical to the probability distribution of the reference signal,
the perturbation processing refers to a processing that makes a fine structure of a frequency spectrum of the input signal within a resolution bandwidth changed randoml, and
the isospectral processing refers to a processing that makes a power distribution of a spectrum of the output signal close to a power distribution of the target spectrum.

2. The apparatus according to claim 1, wherein a probability distribution of the input signal at a first time of iteration is arbitrary.

3. The apparatus according to claim 1, wherein the isoprobabilistic processing comprises:
amplitude sorting, in which the input signal and the reference signal are sorted respectively according to amplitudes of their respective data sample points, and temporal position coordinates of the sorted data sample points of the input signal in an original signal sequence are recorded;
amplitude replacement, in which amplitudes of the sorted data sample points of the input signal are replaced with amplitudes of the sorted data sample points of the reference signal; and
time sorting, in which all data sample points of the input signal with the amplitude replaced are resorted according to recorded temporal position coordinates, so as to obtain an isoprobabilistic signal.

4. The apparatus according to claim 1, wherein the isoprobabilistic processing comprises:
position locking, in which all data sample points in the input signal and the reference signal at required temporal positions are locked, so data sample points locked do not participate in a subsequent process of isoprobabilistic processing;
amplitude sorting, in which other data sample points in the input signal and the reference signal are sorted respectively according to amplitudes of data sample points, and temporal position coordinates of the other sorted data sample points of the input signal in an original signal sequence are recorded;
amplitude replacement, in which amplitudes of the other sorted data sample points of the input signal are replaced with amplitudes of the other sorted data sample points of the reference signal; and
time sorting, in which all data sample points of the input signal with the amplitudes replaced are resorted according to recorded temporal position coordinates, so as to obtain an isoprobabilistic signal.

5. The apparatus according to claim 1, wherein the perturbation processing comprises:
time-frequency domain transform, in which the input signal is transformed from time domain to frequency domain;
spectral interval division, in which the an entire frequency spectrum of the input signal is divided into multiple frequency intervals; and
perturbation processing, in which perturbation is performed on frequency components of the input signal in the frequency intervals so as to change fine structures of spectral lines in the frequency intervals, thereby obtaining a perturbation signal.

6. The apparatus according to claim 5, wherein the perturbation processing comprises coordination perturbation, whereby the frequency intervals are divided at equal intervals, identical perturbation processing is performed on all the frequency intervals, and a coordination perturbation process performed in a former iteration and a coordination perturbation process performed in a latter iteration are independent of each other.

7. The apparatus according to claim 1, wherein the isospectral processing comprises:
frequency spectrum adjustment, in which frequency spectrum adjustment is performed on the input signal so that a difference between a frequency spectrum of the input signal after adjustment and a target frequency spectrum is smaller than a difference between the frequency spectrum of the input signal before adjustment and the target frequency spectrum; and
time-frequency domain inverse transform, in which a signal with the frequency spectrum adjusted is transformed from frequency domain back to time domain, and real part taking operation is performed on the obtained signal so as to obtain an isospectral signal.

8. The apparatus according to claim 1, wherein the target probability distribution is a continuous real variable.

9. The apparatus according to claim 8, wherein after the isospectral processing, the processor further performs the following processing:
determining whether an iteration termination condition is satisfied;
terminating iteration, provided the iteration termination condition is satisfied, and taking an isospectral signal obtained by the isospectral processing as a signal that satisfies the requirement on the target probability distribution and the requirement on the target frequency spectrum; and
proceeding with an iteration cycle process provided the iteration termination condition is unsatisfied, and taking the isospectral signal obtained by the isospectral processing as the input signal of the isoprobabilistic processing.

10. The apparatus according to claim 9, wherein the iteration termination condition is that a difference between the isospectral signal and the target probability distribution is smaller than a preset threshold.

11. The apparatus according to claim 8, wherein after the isoprobabilistic processing, the processor further performs the following processing:
determining whether an iteration termination condition is satisfied;
terminating iteration, provided the iteration termination condition is satisfied, and taking the isoprobabilistic signal obtained by the isoprobabilistic processing as a signal that satisfies the requirement on the target probability distribution and the requirement on the target frequency spectrum; and
proceeding with an iteration cycle process provided the iteration termination condition is unsatisfied, and taking the isoprobabilistic signal obtained by the isoprobabilistic processing as the input signal of the isospectral processing or perturbation processing.

12. The apparatus according to claim 11, wherein after the isospectral processing, the processor feeds back the signal obtained by the isospectral processing to the isoprobabilistic processing, and the signal is taken as an input signal in a next iteration of the isoprobabilistic processing.

13. The apparatus according to claim 11, wherein,
provided the distribution of the target frequency spectrum is a notched signal, the iteration termination condition is that a notched depth of the isoprobabilistic signal is greater than a preset threshold;
provided the distribution of the target frequency spectrum is a notched signal containing multiple notched frequency bands, the iteration termination condition is that notched depths of all notched frequency bands of the isoprobabilistic signal are greater than a preset threshold;
provided the distribution of the target frequency spectrum is a band-pass signal, the iteration termination condition is that a signal-to-noise ratio of the isoprobabilistic signal is greater than a preset threshold; and
provided the distribution of the target spectrum is another type of spectral distribution than the notched signal and the band-pass signal, the iteration termination condition is that a spectral difference between the isoprobabilistic signal and the target frequency spectrum is lower than a preset threshold.

14. The apparatus according to claim 1, wherein the target probability distribution is a discrete real variable, the reference signal is a discrete reference signal, and the processor further performs the following processing:
performing diffusion processing on the discrete reference signal, converting the discrete reference signal into a diffusion signal which is continuously distributed, and replacing the reference signal with the diffusion signal.

15. The apparatus according to claim 14, wherein the diffusion processing is variable, whereby as an iteration process progresses, a magnitude of diffusion component contained in the diffusion signal gradually decreases.

16. The apparatus according to claim 14, wherein after the isospectral processing, the processor further performs the following processing:
determining whether an iteration termination condition is satisfied;
terminating iteration, provided the iteration termination condition is satisfied, and taking the isospectral signal obtained by the isospectral processing as a signal that satisfies the requirement on the target probability distribution and the requirement on the target frequency spectrum; and
proceeding with an iteration cycle process provided the iteration termination condition is unsatisfied, and taking the isospectral signal obtained by the isospectral processing as the input signal of the isoprobabilistic processing.

17. The apparatus according to claim 16, wherein the iteration termination condition is that a difference between the isospectral signal and the target probability distribution is less than a preset threshold, and a magnitude of diffusion component contained in the diffusion signal is less than a preset threshold.

18. The apparatus according to claim 14, wherein after the isoprobabilistic processing, the processor further performs the following processing:
determining whether an iteration termination condition is satisfied;
terminating iteration, provided the iteration termination condition is satisfied, and taking the isoprobabilistic signal obtained by the isoprobabilistic processing as a signal that satisfies the requirement on the target probability distribution and the requirement on the target frequency spectrum; and
proceeding with an iteration cycle process provided the iteration termination condition is unsatisfied, and taking the isoprobabilistic signal obtained by the isoprobabilistic processing as the input signal of the isospectral processing or the perturbation processing.

19. The apparatus according to claim 18, wherein after the isospectral processing, the processor feeds back the signal obtained by the isospectral processing to the isoprobabilistic processing, and the signal is taken as an input signal in a next iteration of the isoprobabilistic processing.

20. The apparatus according to claim 18, wherein,
provided the distribution of the target frequency spectrum is a notched signal, the iteration termination condition is that a notched depth of the isoprobabilistic signal is greater than a preset threshold, and a magnitude of diffusion component contained in the diffusion signal is less than a preset threshold;
provided the distribution of the target frequency spectrum is a notched signal containing multiple notched frequency bands, the iteration termination condition is that notched depths of all notched frequency bands of the isoprobabilistic signal are greater than a preset threshold, and the magnitude of diffusion component contained in the diffusion signal is less than the preset threshold;
provided the distribution of the target frequency spectrum is a band-pass signal, the iteration termination condition is that a signal-to-noise ratio of the isoprobabilistic signal is greater than a preset threshold, and the magnitude of diffusion component contained in the diffusion signal is less than the preset threshold; and
provided the distribution of the target spectrum is another type of spectral distribution than the notched signal and the band-pass signal, the iteration termination condition is that a spectral difference between the isoprobabilistic signal and the target frequency spectrum is lower than a preset threshold, and the magnitude of diffusion component contained in the diffusion signal is less than the preset threshold.

21. The apparatus according to claim 1, wherein the target probability distribution is a continuous or discrete complex variable, and the processor performs the following processing:
taking the reference signal as a standard, cyclically performing isoprobabilistic processing and isospectral processing respectively, or cyclically performing isoprobabilistic processing, perturbation processing and isospectral processing respectively, on an I-branch signal and a Q-branch of the input signal, until an obtained I-branch signal and an obtained Q-branch signal respectively satisfy the requirement on the target probability distribution and the requirement on the target frequency spectrum; and
combining the obtained I-branch signal and the obtained Q-branch signal to obtain a complex signal that satisfies the requirement on the target probability distribution and the requirement on the target frequency spectrum.

22. A measurement system of a nonlinear system, comprising:
the apparatus as claimed in claim 1 which is configured to generate a target signal; and
a measuring device configured to measure nonlinear characteristics of the nonlinear system according to the target signal.

23. A test instrument, comprising:
a signal generator configured to generate a target signal, the signal generator being implemented by the apparatus as claimed in claim 1; and
a test device configured to perform test according to the target signal.

24. A test instrument, comprising:
a receiver configured to receive a target signal, the target signal being generated by the apparatus as claimed in claim 1; and
a test device configured to perform test according to the target signal.
